(19) United States
(12) Patent Application Publication
(10) Pub. No.: US 2026/0156424 A1
(43) Pub. Date: Jun. 4, 2026

(54) INGRESS PROTECTION FOR ENABLING FIELD CLEANING OF EAR-WEARABLE AUDIO DEVICES

(71) Applicant: Starkey Laboratories, Inc., Eden Prairie, MN (US)

(72) Inventors: Viktor Klymko, Minneapolis, MN (US); Jay Stewart, Eden Prairie, MN (US); David Tourtelotte, Eden Prairie, MN (US)

(21) Appl. No.: 19/404,519

(22) Filed: Dec. 1, 2025

Related U.S. Application Data
(60) Provisional application No. 63/727,007, filed on Dec. 2, 2024.

(51) Int. Cl. H04R 25/00; H04R 1/02; H04R 1/10

(52) U.S. Cl. CPC H04R 25/654; H04R 1/023; H04R 1/1016

(57) ABSTRACT

Embodiments herein relate to ear-wearable devices. In an embodiment, an ear-wearable device is included having a housing is included having an aperture end; and an ear canal end defining an acoustic outlet; a receiver within the housing; an acoustic tube between the receiver and the acoustic outlet; a foreign material barrier disposed over a portion of the acoustic tube; and a tip portion disposed at the ear canal end, wherein the tip portion is configured to move between a first position and a second position; wherein a movement of the tip portion from the first position to the second position is configured to move foreign material in a direction away from the acoustic tube. Other embodiments are also included herein.

This application claims the benefit of U.S. Provisional Application No. 63/727,007, filed Dec. 2, 2024, the content of which is incorporated herein by reference in its entirety.

### FIELD

Embodiments herein relate to in-ear audio devices and more particularly to ingress protection for enabling field cleaning of in-ear audio devices.

### BACKGROUND

Modern ear-wearable audio devices, such as hearing assistance devices or hearing aids, are electronic instruments worn in or around the ear that generate or amplify sound. Ear-wearable audio devices often include an enclosure or housing with one or more openings for a microphone that senses sound, electronics including processing electronics, and a speaker or receiver to play sound for the wearer. One of the recurring problems with such devices is the accumulation of foreign matter interfering with the performance of the internal components. The accumulation of foreign material reduces both the overall lifetime of ear-wearable audio devices and the maximum time the devices can perform adequately between cleanings.

### SUMMARY

In a first aspect, an ear-wearable device can be included. The ear-wearable device can include a housing having an aperture end and an ear canal end defining an acoustic outlet. The ear-wearable device can include a receiver within the housing. The ear-wearable device can include an acoustic tube between the receiver and the acoustic outlet. The ear-wearable device can include a foreign material barrier disposed over a portion of the acoustic tube. The ear-wearable device can include a tip portion disposed at the ear canal end. In various embodiments, the tip portion can be configured to move between a first position and a second position. In various embodiments, a movement of the tip portion from the first position to the second position can be configured to move foreign material in a direction away from the acoustic tube.

In a second aspect, in addition to one or more of the preceding or following aspects, or in the alternative to some aspects, the foreign material barrier includes a mesh.

In a third aspect, in addition to one or more of the preceding or following aspects, or in the alternative to some aspects, the foreign material barrier includes a plate defining openings.

In a fourth aspect, in addition to one or more of the preceding or following aspects, or in the alternative to some aspects, the tip portion includes the foreign material barrier, wherein the movement of the tip portion from the first position to the second position causes the foreign material barrier to move with respect to the housing. In a fifth aspect, in addition to one or more of the preceding or following aspects, or in the alternative to some aspects, wherein when in the second position, the foreign material can be pushed though the foreign material barrier without obstructing the acoustic tube.

In a sixth aspect, in addition to one or more of the preceding or following aspects, or in the alternative to some aspects, the tip portion includes a mesh.

In a seventh aspect, in addition to one or more of the preceding or following aspects, or in the alternative to some aspects, the foreign material barrier can be disposed on the housing, wherein the movement of the tip portion from the first position to the second position causes the tip portion to move with respect to the foreign material barrier.

In an eighth aspect, in addition to one or more of the preceding or following aspects, or in the alternative to some aspects, the tip portion can be configured to rotate between the first position and the second position.

In a ninth aspect, in addition to one or more of the preceding or following aspects, or in the alternative to some aspects, the ear-wearable device can further include a pivot bearing, wherein the tip portion can be configured to rotate about the pivot bearing, and a stopper notch configured to fix the tip portion in the first position.

In a tenth aspect, in addition to one or more of the preceding or following aspects, or in the alternative to some aspects, the tip portion can be configured to translate laterally between the first position and the second position.

In an eleventh aspect, in addition to one or more of the preceding or following aspects, or in the alternative to some aspects, the ear-wearable device can further include a guiding rail, wherein the tip portion can be configured to translate along the guiding rail, and a stopper notch configured to limit the translation of the tip portion. In a twelfth aspect, in addition to one or more of the preceding or following aspects, or in the alternative to some aspects, wherein, when the tip portion can be in the first position, the tip portion covers the acoustic outlet.

In a thirteenth aspect, in addition to one or more of the preceding or following aspects, or in the alternative to some aspects, wherein, when the tip portion can be in the second position, at least 90% of the acoustic tube proximal portion can be not covered by the tip portion, and the foreign material barrier does not overlap with the housing.

In a fourteenth aspect, an ear-wearable device can be included. The ear-wearable device can include a housing having an aperture end and an ear canal end defining an acoustic outlet. The ear-wearable device can include a receiver within the housing. The ear-wearable device can include an acoustic tube between the receiver and the acoustic outlet. The acoustic tube can include an acoustic tube proximal portion and an acoustic tube distal portion. The ear-wearable device can include a foreign material barrier disposed between the acoustic tube proximal portion and the acoustic tube distal portion. The ear-wearable device can include a tip portion disposed at the ear canal end. The tip portion can include the acoustic tube distal portion. In various embodiments, the tip portion can be configured to move between a first position and a second position. In various embodiments, a movement of the tip portion from the first position to the second position can be configured to move foreign material in a direction away from the acoustic tube.

In a fifteenth aspect, in addition to one or more of the preceding or following aspects, or in the alternative to some aspects, the foreign material barrier can be disposed on the tip portion, wherein the movement of the tip portion from the first position to the second position causes the foreign material barrier to move with respect to the housing.

In a sixteenth aspect, in addition to one or more of the preceding or following aspects, or in the alternative to some aspects, the foreign material barrier can be disposed on the housing, wherein the movement of the tip portion from the first position to the second position causes the tip portion to move with respect to the foreign material barrier.

In a seventeenth aspect, in addition to one or more of the preceding or following aspects, or in the alternative to some aspects, the tip portion can be configured to rotate between the first position and the second position or translate laterally between the first position and the second position.

In an eighteenth aspect, a method of moving foreign material from an ear-wearable device is included. The ear-wearable device can include a housing defining an acoustic outlet, a receiver disposed inside the housing, an acoustic tube defined between the receiver and the acoustic outlet, and a foreign material barrier disposed over a portion of the acoustic tube. The method can include moving a tip portion from a first position to a second position, wherein a movement of the tip portion from the first position to the second position moves foreign material in a direction away from the acoustic tube.

In a nineteenth aspect, in addition to one or more of the preceding or following aspects, or in the alternative to some aspects, the foreign material barrier can be disposed on the tip portion, wherein the movement of the tip portion from the first position to the second position causes the foreign material barrier to move with respect to the housing, can further include the step of removing the foreign material from the foreign material barrier.

In a twentieth aspect, in addition to one or more of the preceding or following aspects, or in the alternative to some aspects, the method can further include applying heat to the acoustic channel prior to moving the tip portion from the first position to the second position.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a partial cross-sectional view of ear anatomy in accordance with various embodiments herein.

FIG. 2 is a partial cross-sectional view of an in-the-ear style custom ear-wearable device in accordance with various embodiments herein.

FIG. 3 is a partial cross-sectional view of an ear-wearable device disposed within the ear of a user in accordance with various embodiments herein.

FIG. 4 is a perspective view of an in-the-ear style custom ear-wearable device with a tip portion in a first position in accordance with various embodiments herein.

FIG. 5 is a perspective view of the in-the-ear style custom ear-wearable device of FIG. 4 with the tip portion in a second position in accordance with various embodiments herein.

FIG. 6 is a top view of a portion of an in-the-ear style custom ear-wearable device with a tip portion in a second position in accordance with various embodiments herein.

FIG. 7 is a schematic front view of a portion of an in-the-ear style custom ear-wearable device with a tip portion in a second position in accordance with various embodiments herein.

FIG. 8 is a schematic top view of a portion of an in-the-ear style custom ear-wearable device with a tip portion in a second position in accordance with various embodiments herein.

FIG. 9 is a schematic front view of a portion of the in-the-ear style custom ear-wearable device of FIG. 8 with a tip portion in a first position in accordance with various embodiments herein.

FIG. 10 is a schematic front view of a portion of the in-the-ear style custom ear-wearable device of FIG. 8 with a tip portion in a second position in accordance with various embodiments herein.

FIG. 11 is a schematic top view of a portion of an in-the-ear style custom ear-wearable device with a tip portion in a second position in accordance with various embodiments herein.

FIG. 12 is a schematic front view of a portion of the in-the-ear style custom ear-wearable device of FIG. 11 with a tip portion in a first position in accordance with various embodiments herein.

FIG. 13 is a schematic front view of a portion of the in-the-ear style custom ear-wearable device of FIG. 11 with a tip portion in a second position in accordance with various embodiments herein.

FIG. 14 is a schematic top view of a portion of an in-the-ear style custom ear-wearable device with a tip portion in a second position in accordance with various embodiments herein.

FIG. 15 is a schematic front view of a portion of the in-the-ear style custom ear-wearable device of FIG. 14 with a tip portion in a first position in accordance with various embodiments herein.

FIG. 16 is a schematic front view of a portion of the in-the-ear style custom ear-wearable device of FIG. 14 with a tip portion in a second position in accordance with various embodiments herein.

FIG. 17 is a schematic top view of a portion of an in-the-ear style custom ear-wearable device with a tip portion in a second position in accordance with various embodiments herein.

FIG. 18 is a schematic top view of a portion of an in-the-ear style custom ear-wearable device with a tip portion in a second position in accordance with various embodiments herein.

FIG. 19 is a perspective view of a case in accordance with various embodiments herein.

FIG. 20 is a schematic block diagram with various components of an ear-wearable device in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

One of the recurring problems with ear-wearable devices is the accumulation of foreign matter interfering with the performance of the internal components. For instance, the performance of audio components placed in the ear canal tends to suffer when foreign matter plugs the acoustic ports. Blockage of the acoustic ports can lead to dramatic change in acoustic impedance and an effective reduction in device output. For this reason, it is desirable for an ear-wearable device to allow and facilitate proactively removing foreign material from its acoustic passages.

In various embodiments, an ear-wearable device can include a housing having an aperture end and an ear canal end defining an acoustic outlet. The ear-wearable device can include a receiver within the housing and an acoustic tube between the receiver and the acoustic outlet. The ear-wearable device can include a foreign material barrier disposed over a portion of the acoustic tube and a tip portion disposed at the ear canal end. In various embodiments, the tip portion is configured to move between a first position and a second position. In various embodiments, the movement of the tip portion from the first position to the second position is configured to move foreign material in a lateral direction, away from the acoustic tube.

In various embodiments, the movement of the tip portion from the first position to the second position is configured to remove at least a portion of the foreign material that has accumulated in the acoustic channel during use. In some embodiments, when the tip portion is in the second position, the mesh is exposed for easy cleaning. For instance, foreign material can be pushed through the mesh using a cleaning tool. The movable foreign material barrier is configured to simplify the cleaning of and prolong the life cycle of the ear-wearable device.

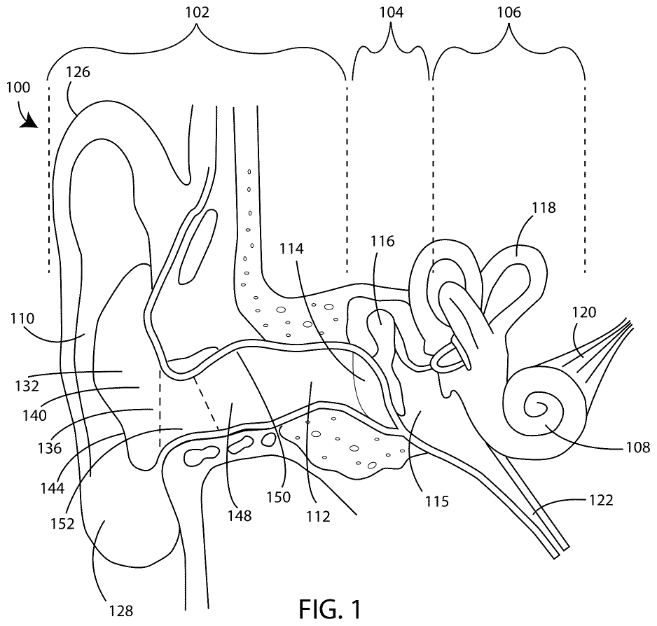

### Ear Anatomy and Ear-wearable Device (FIGS. 1-3)

The term “ear-wearable device” shall refer to devices worn on or in the ear. Though not required, in some embodiments, ear-wearable devices can aid a person with hearing, such as a hearing assistance devices or hearing aids. Examples of hearing assistance devices are devices that can aid a person with impaired hearing or that can produce sounds, optimized sounds, or processed sound for persons with normal hearing or impaired hearing. Hearing assistance devices herein can include hearables (e.g., wearable earphones, headphones, earbuds, virtual reality headsets), hearing aids (e.g., hearing instruments), cochlear implants, and bone-conduction devices, for example. Hearing assistance devices that are also custom ear-wearable devices include, but are not limited to, in-the ear (ITE), in-the-canal (ITC), invisible-in-canal (IIC), or completely-in-the-canal (CIC) type hearing assistance devices, or some combination of the above. Ear-wearable devices can also be used to block sound or even be unrelated to hearing. In some embodiments herein, an ear-wearable device may also take the form of a piece of jewelry, or a component of frames of glasses, which may be attached to the head on or about the ear. Ear-wearable devices can be worn within the ear in some embodiments.

Custom ear-wearable devices include at least one component, such as a shell, which is customized to the user's anatomy. Custom ear-wearable devices provide a number of advantages to the user. For instance, the microphone can collect sound from in the ear itself, rather than from behind the ear. This takes advantage of the ear's pinna, the external part of the ear, to funnel sounds to the microphone. The microphone is also more shielded from wind in some embodiments. In various embodiments, custom ear-wearable devices are formed as a single housing, rather than two parts, and can therefore be easier for the user to put on.

Examples of different types of custom ear-wearable devices include the following, which are mentioned from larger to smaller: in-the-ear (ITE) ear-wearable devices, in-the-canal (ITC) ear-wearable devices, completely-in-canal (CIC) ear-wearable devices, and invisible (IIC) ear-wearable devices. Each of these custom ear-wearable devices has a different size and mates with a differently sized portion of the user's ear cavity.

Referring now to FIG. 1, a partial cross-sectional view of ear anatomy 100 is shown. The three parts of the ear anatomy 100 are the outer ear 102, the middle ear 104 and the inner ear 106. The inner ear 106 includes the cochlea 108. The outer ear 102 includes the pinna 110, ear canal 112, and the tympanic membrane 114 (or eardrum). The middle ear 104 includes the tympanic cavity 115, auditory bones 116 (malleus, incus, stapes) and the semicircular canals 118. The inner ear 106 includes the cochlea 108, and the auditory nerve 120. The pharyngotympanic tube 122 is in fluid communication with the Eustachian tube and helps to control pressure within the middle ear generally making it equal with ambient air pressure.

Sound waves enter the ear canal 112 and make the tympanic membrane 114 vibrate. This action moves the tiny chain of auditory bones 116 (ossicles - malleus, incus, stapes) in the middle ear 104. The last bone in this chain contacts the membrane window of the cochlea 108 and makes the fluid in the cochlea 108 move. The fluid movement then triggers a response in the auditory nerve 120.

Many components of the outer ear 102 interact with one or more styles of custom ear-wearable device. The helix 126 is the outer rim of the ear that extends from the scalp to the earlobe 128. The concha 132 is the deepest depression of the pinna 110 and is located at the opening 136, to the ear canal 112. The term ear cavity 140 will be used herein to describe the spaces defined by the concha 132 and the ear canal 112. The tragus (not shown in FIG. 1) is a small, pointed eminence positioned in front of the concha 132 and the antitragus 144 is a prominence opposite the tragus.

The ear canal 112 itself has physical features that custom ear-wearable devices contact. The bulbous area 148 and the second bend 150 are physical features of the ear canal 112, and the shell 204 of the ear-wearable device 200 is shaped to contact these features, in various embodiments. For example, an acoustic seal location 152, between the dashed lines in FIG. 1, is the portion of the ear anatomy where a circumferential seal will be formed with the ear-wearable device, in various embodiments.

Ear-wearable devices can include an enclosure, such as a housing or shell, within which internal components are disposed. Components of ear-wearable devices described herein can include a control circuit, digital signal processor (DSP), memory (such as non-volatile memory), power management circuitry, a data communications bus, one or more communication devices (e.g., a radio, a near-field magnetic induction device), one or more antennas, one or more microphones, a receiver/speaker, and various sensors as described in greater detail below. More advanced ear-wearable devices can incorporate a long-range communication device, such as a BLE (BLUETOOTH® low energy) transceiver or other type of radio frequency (RF) transceiver.

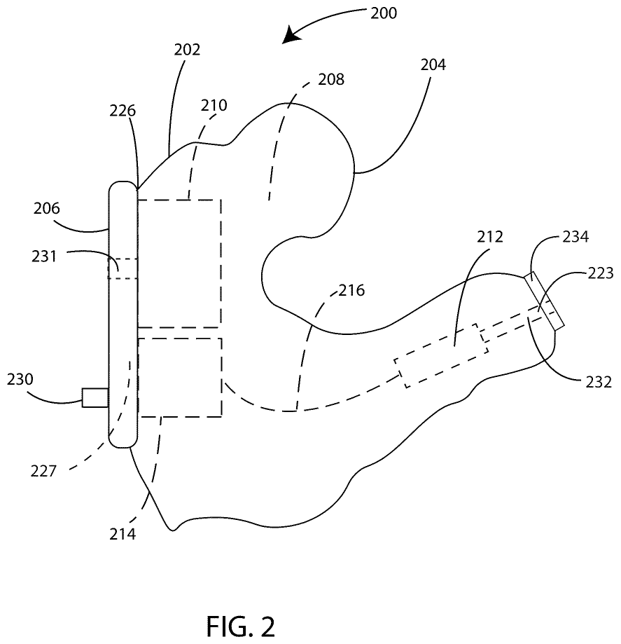

Referring now to FIG. 2, a schematic view of an in-the-ear style custom ear-wearable device is shown in accordance with various embodiments herein. The ear-wearable device 200 can include an ear-wearable device housing 202 formed by a shell 204 and a faceplate 206. The shell 204 is custom shaped to mate with the user's ear anatomy and defines an internal shell cavity 208, an acoustic outlet 223, and a second shell opening 227 at the largest entrance to the shell cavity 208. The shell 204 can be manufactured utilizing any suitable technique or techniques, e.g., injection-molding, 3D printing, etc. The shell 204 can include any suitable material or materials, e.g., silicone, urethane, acrylates, flexible epoxy, acrylated urethane, and combinations thereof.

The faceplate 206 is attached to the shell at the second shell opening 227 to enclose the shell cavity 208. The ear-wearable device housing 202 can define a battery compartment 210 in which a battery can be disposed to provide power to the device. The housing 202 can also define a component compartment 214 that can contain electrical and other components including but not limited to a microphone, a processor, memory, various sensors, one or more communication devices, power management circuitry, and a control circuit. A cable 216 or connecting wire can include one or more electrical conductors and provide electrical communication between components inside of the component compartment 214 and components inside of the shell cavity 208.

The shell 204 extends from an ear canal end 222 to an aperture end 226. The ear canal end 222 can interface with the ear canal and can have an acoustic outlet 223. At the aperture end 226, the shell 204 defines a second shell opening 227 that is closed by the faceplate 206. The faceplate 206 is sealed to the shell 204. The faceplate 206 is shown in FIG. 2 only in a side view but can include many features and structures. A user input device 230 is shown as part of the faceplate in FIG. 2, and can be a button, lever, switch, dial, or other input device. One or more microphones 231 may also be mounted to the faceplate 206. The faceplate 206 may also include a battery door, a pull handle, and other features.

The ear-wearable device 200 can also include a receiver 212 positioned within the shell cavity 208. In some embodiments, the receiver 212 can be suspended within the shell cavity 208 using one or more tubes, wires, or the like. In some embodiments, the shell cavity 208 can be filled with a gel-like material, such as an adhesive, which surrounds the receiver 212. The receiver 212 can convert electrical impulses into sound and can also be referred to as an electroacoustic transducer or speaker. In the context of ear-wearable devices, one or more microphones (e.g., microphone(s) 231 on faceplate 206) gather acoustic energy (sound) from the surrounding environment and convert the acoustic energy into electrical signals. In some embodiments, the electrical signals are then transmitted to an amplifier which increases the amplitude of the electric signals. The amplified electric signals are then transmitted to the receiver 212, which converts the received electric signals into sounds. The sounds are then transmitted to a user's ear via an acoustic outlet at the acoustic outlet 223 of the ear-wearable device 200. Any suitable type or types of receiver can be used in the ear-wearable device 200 including, but not limited to armature receivers, moving coil receivers, or the like.

In various embodiments, sounds generated by the receiver 212 travel through an acoustic tube 232 and exit the ear-wearable device 200 at the acoustic outlet 223. In various embodiments, the acoustic tube 232 is defined by an acoustic channel wall. In some embodiments, the acoustic channel wall is formed from a structure that is separate from the ear-wearable device housing 202 and is then adhered or otherwise connected to the housing 202 surrounding the acoustic outlet 223. Alternatively, the acoustic channel wall can be formed from a portion of the ear-wearable device housing 202, such as during a molding process that forms the shell 204.

In various embodiments, the acoustic outlet 223 can provide an entry point for foreign matter into the ear-wearable device 200. Foreign matter as defined herein is any matter other than air that can enter the ear-worn device and can include skin cells, dust, body oil, food, hairspray, ear wax, water, or the like. Performance of the audio components placed in ear canal tend to suffer when foreign matter plugs the acoustic ports (e.g., acoustic tube 232). In severe cases, foreign matter can collect on a wall of the acoustic tube 232 to the point that the acoustic tube is almost entirely obstructed, resulting in dramatic change in acoustic impedance and effective reduction of device output. For this reason, ear worn devices often come with occlusion domes and protective grids for receivers that regular cleaning and replacement.

In various embodiments, the ear-wearable device 200 can include a foreign material barrier (not shown in this view) and a tip portion 234 disposed at the ear canal end 222. In various embodiments, the tip portion 234 can be configured to move between a first position and a second position. In various embodiments, movement of the tip portion 234 from the first position to the second position is configured to move foreign material in a lateral direction away from the acoustic tube and simplify cleaning of the foreign material from the ear-wearable device 200.

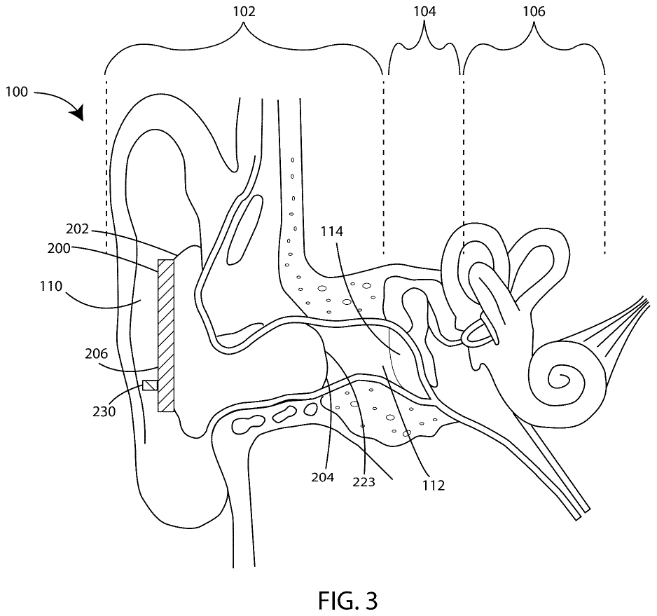

Referring now to FIG. 3, a schematic view of an ear-wearable device 200 disposed within the ear of a user is shown in accordance with various embodiments herein. The housing 202 of the ear-wearable device 200 is defined by the shell 204, which is positioned within the ear canal 112, and the faceplate 206, which is positioned in the concha. The user input device 230 on the faceplate 206 is accessible to be manipulated by the user without having to remove the ear-wearable device from their ear. The acoustic outlet 223 is positioned close to the user's tympanic membrane. In various embodiments, the shell 204 fits properly within the user's ear cavity. A proper fit is usually one in which the ear-wearable device forms an acoustic seal with the user's ear cavity, so that it is contacting the ear cavity around a circumference of the ear-wearable device at some location on the shell 204 of the ear-wearable device 200. A proper fit is also comfortable for the user, so that the shell 204 does not put too much pressure on the walls of the ear canal 112 or features of the concha. In various embodiments, the receiver 212 (FIG. 2) is positioned within the shell 204 at or near the ear canal end 222 of the shell 204.

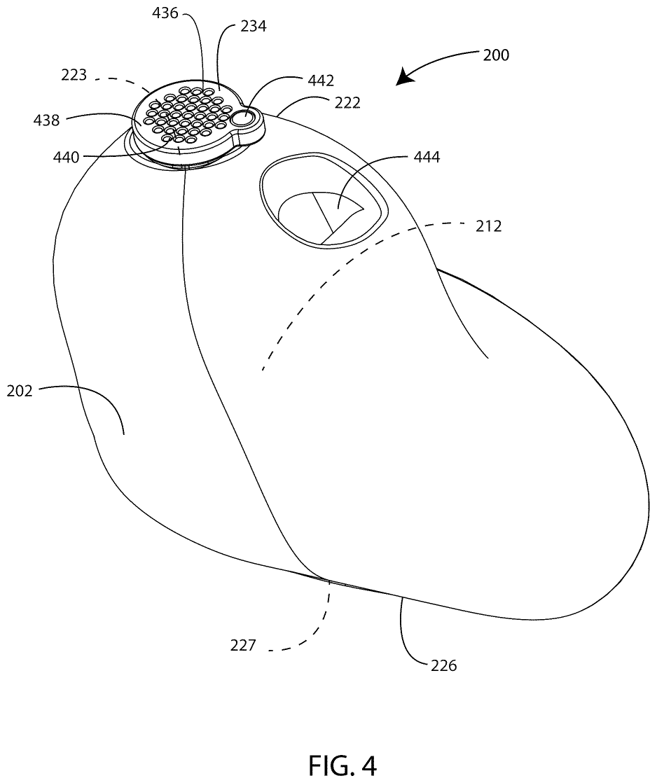

### Foreign Material Guard as Tip Portion—Rotating Tip (FIGS. 4-7)

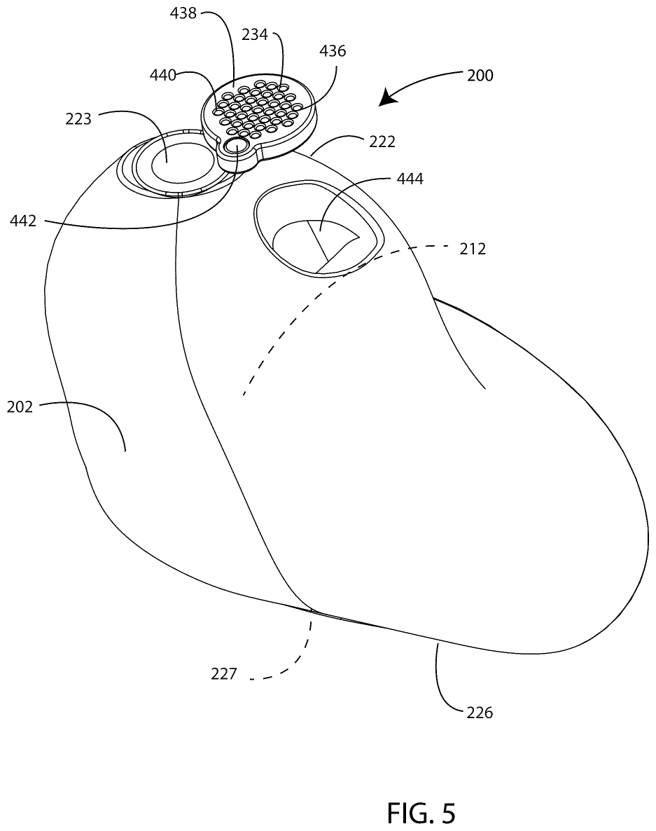

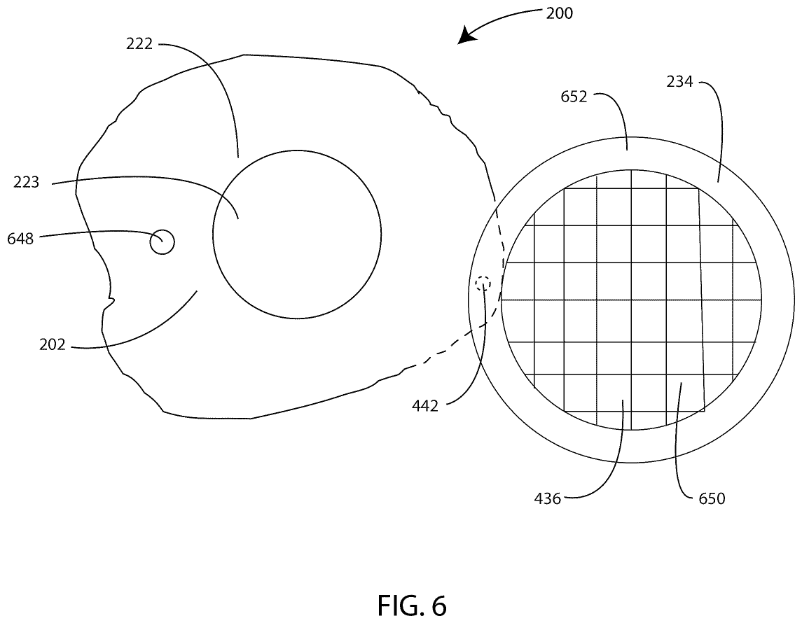

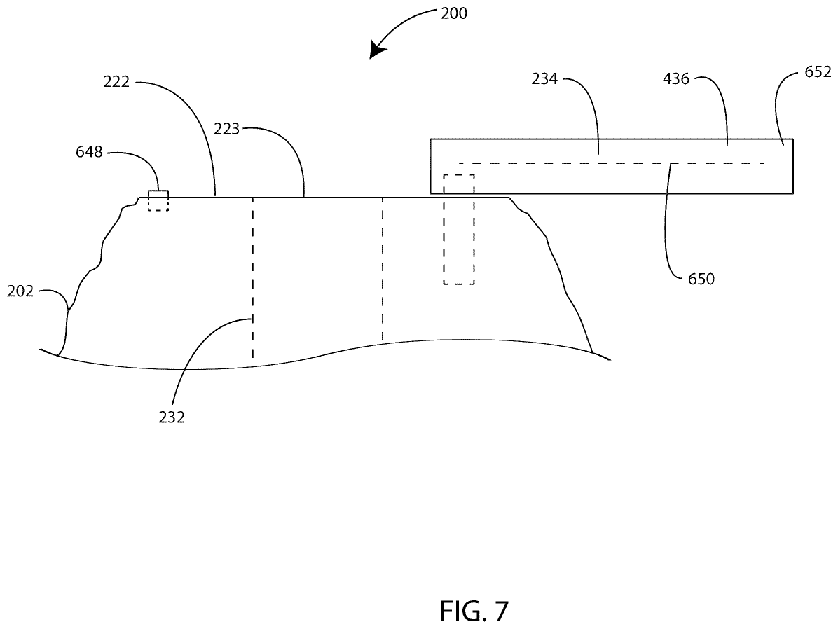

Referring now to FIGS. 4-7, schematic views of an in-the-ear style custom ear-wearable device are shown in accordance with various embodiments herein. FIG. 4 depicts a schematic perspective view of an in-the-ear style custom ear-wearable device with a tip portion in a first position. FIG. 5 depicts a schematic perspective view of the in-the-ear style custom ear-wearable device with the tip portion in a second position. FIG. 6 depicts a schematic top view of a portion of an in-the-ear style custom ear-wearable device with a tip portion in a second position. FIG. 7 depicts a schematic front view of a portion of an in-the-ear style custom ear-wearable device with a tip portion in a second position.

In various embodiments, the ear-wearable device 200 can include a housing 202 having an aperture end 226 and an ear canal end 222 defining an acoustic outlet 223. The ear-wearable device 200 can further include a receiver 212 within the housing 202 and an acoustic tube 232 (best seen in FIG. 7) between the receiver 212 and the acoustic outlet 223.

In some embodiments, such as shown in FIGS. 4-5, the ear-wearable device 200 can include a vent 444. The vent 444 can be any suitable opening or passageway that allows air and sound to move through the ear-wearable device. In various embodiments, the vent 444 can serve a plurality of functions such as reducing the occlusion effect, improving user comfort, controlling low-frequency amplification, preventing moisture buildup, or the like.

In various embodiments, the ear-wearable device 200 can include a foreign material barrier 436 disposed over a portion of the acoustic tube 232 and a tip portion 234 disposed at the ear canal end 222. The tip portion 234 can be configured to move between a first position (as seen in FIG. 4) and a second position (as seen in FIGS. 5-7). In various embodiments, a movement of the tip portion 234 from the first position to the second position is configured to move foreign material in a lateral direction away from the acoustic tube 232. A lateral direction as defined herein is a direction parallel to the plane defined by the foreign material barrier.

In various embodiments the foreign material barrier 436 is configured to prevent foreign material from entering the acoustic tube 232 via the acoustic outlet 223 while enabling sound generated at the receiver 212 to propagate through into the ear of a wearer. In some embodiments, the foreign material barrier 436 can be permeable to gases and impermeable to solids and some liquids. While not intending to be bound by theory, it is believed that including a foreign material barrier 436 over the acoustic outlet 223 can increase the lifespan of the internal components of the ear-wearable device 200 (e.g., receiver) by preventing debris (e.g., earwax, water, oils) from entering the acoustic tube 232 via the acoustic outlet 223.

In some embodiments, such as depicted by FIGS. 4-5, the foreign material barrier 436 is formed from a plate 438 defining openings 440. In the example of FIGS. 4-5, the plate 438 includes a plurality of substantially circular openings 440 extending through the depth of the plate. However, any other suitable shape, size, and/or configuration of openings that allow sounds to propagate through the foreign material barrier 436 while blocking foreign material from entering the ear-wearable device 200 may be used. In some embodiments, the foreign material barrier 436 is an acoustically-transparent foreign material barrier.

In some embodiments, such as depicted by FIGS. 6-7, the foreign material barrier 436 is formed from a mesh 650. For instance, the foreign material barrier 436 can include a mesh 650 surrounded by a frame 652. The mesh 650 can be any suitable material or materials that is permeable to gases and impermeable to solids and liquids. In some embodiments, the mesh can be a very fine mesh. Examples of appropriate mesh layers are sold by Saati S.p.A. of Vilano, Italy, under the tradename Acoustex, including SAATI Nanomesh AETHEX™ material or the like.

In some embodiments, the tip portion 234 includes the foreign material barrier 436. In some embodiments, the tip portion 234 is integral with the foreign material barrier 436. In the example of FIGS. 4-7, the tip portion 234 and the foreign material barrier 436 are the same part, such that a movement of the tip portion 234 is equivalent to a movement of the foreign material barrier 436. In such embodiments, the movement of the tip portion 234 from the first position (as seen in FIG. 4) to the second position (as seen in FIGS. 5-7) causes the foreign material barrier 436 to move with respect to the housing 202. For instance, the movement of the tip portion 234 from the first position to the second position can transport the foreign material disposed on the foreign material barrier away from the acoustic tube 232.

In various embodiments, when in the first position (as seen in FIG. 4), the foreign material barrier 436 is configured to cover the acoustic outlet 223. In various embodiments, when in the first position, the foreign material barrier 436 is configured to prevent foreign material from entering the acoustic tube 232 of the ear-wearable device 200 via the acoustic outlet 223. In various embodiments, the foreign material barrier 436 is configured to be placed in the first position during normal use, such as while the ear-worn device is being worn by a user.

In various embodiments, when in the second position (as seen in FIGS. 5-7), the foreign material barrier 436 does not cover the acoustic outlet 223. In the example of FIGS. 5-7, the entirety of the acoustic outlet 223 is not covered by the foreign material barrier 436. In alternate embodiments, at least a portion of the acoustic outlet 223 is covered by the foreign material barrier 436 when the tip portion 234 is in the second position. In various embodiments, the foreign material barrier 436 is configured to be placed in the second position for cleaning (e.g., removing foreign material from the foreign material barrier 436).

In various embodiments, when in the second position (as seen in FIGS. 5-7), at least a portion of the foreign material barrier 436 does not overlap with the housing 202. In the example of FIGS. 5-7, the majority of the foreign material barrier 436 does not overlap with the housing 202. In some embodiments, at least 50%, 60%, 70%, 80%, 90%, or 100%, or an amount falling within a range between any of the foregoing, of the foreign material barrier 436 does not overlap with the housing 202.

In various embodiments, the movement of the tip portion 234 from the first position to the second position is configured to move foreign material in a lateral direction away from the acoustic tube 232.

In various embodiments, when in the second position, the foreign material can be removed from the foreign material barrier 436. In some embodiments, when in the second position, the foreign material can be pushed though the foreign material barrier 436 without pushing the foreign material into the acoustic tube 232. In some embodiments, the lateral movement of the foreign material with respect to foreign material barrier 436 caused by the movement of the tip portion 234 allows for the foreign material to become compacted in a particular area of the foreign material barrier resulting in more efficient removal of the foreign material. The foreign material can be removed from the foreign material barrier 436 using any suitable tool or tools such as cloths, brushes, pipe cleaners, or the like. In some embodiments, when in the second position, the ear-wearable device 200 can be turned upside down and water and/or other cleaning fluids can be run through the tip portion 234 causing the foreign material to be rinsed from the foreign material barrier 436.

In various embodiments, such as seen in FIGS. 4-7, the tip portion 234 is configured to rotate between the first position and the second position. In the example of FIGS. 4-7, the tip portion 234 and the foreign material barrier 436 are integral with one and other, such that a movement of the tip portion 234 is equivalent to a movement of the foreign material barrier 436.

In various embodiments, the ear-wearable device 200 can include a pivot bearing 442. In various embodiments, the tip portion 234 is configured to rotate about the pivot bearing 442 between the first position and the second position. As best seen in FIGS. 6-7, the pivot bearing 442 is configured to rotatably connect the tip portion 234 to the housing 202 of the ear-wearable device 200. In some embodiments, the pivot bearing 442 is configured to extend at least part of the way through the tip portion 234 and at least part of the way through the housing 202. In various embodiments, the pivot bearing 442 can be secured to the tip portion 234 and/or the housing 202 by any suitable means such as blunting, retaining rings, or the like.

In various embodiments, the ear-wearable device 200 can include a stopper notch 648. In various embodiments, the stopper notch 648 is configured to fix the tip portion 234 in the first position. For instance, during normal use (e.g., when the ear-wearable device 200 is worn by a user), the tip portion 234 is configured to be in its first position. In such a scenario, it would be undesirable for the tip portion 234 to rotate about its pivot bearing. Accordingly, when the tip portion is in its first position, the stopper notch 648 is configured to engage with the tip portion 234 and retain it in the first position. However, the engagement between the tip portion 234 and the stopper notch 648 is configured to be weak enough such that a tangential force applied to the tip portion (e.g., a user twisting the tip portion) is sufficient to overcome the tension between the tip portion 234 and the stopper notch 648, allowing the tip portion to move from the first position to the second position.

In some embodiments, the stopper notch 648 is further configured to limit the rotation of the tip portion with respect to the housing 202. In some embodiments, the maximum rotation of the tip portion 234 relative to the housing 202 can be greater than or equal to 90°, 105°, 120°, 135°, 150°, 165°, or 180°. In some embodiments, the maximum rotation of the tip portion 234 relative to the housing 202 can be less than or equal to 350 °, 322°, 293°, 265°, 237°, 208°, or 180°. In some embodiments, the maximum rotation of the tip portion 234 relative to the housing 202 can fall within a range of 90°to 350°, or 105°to 322°, or 120° to 293°, or 135°to 265°, or 150 °to 237°, or 165°to 208°, or can be about 180°.

While the embodiments of FIGS. 4-7 show and describe the tip portion 234 rotating between the first position and the second position, other means of actuating the tip portion are described herein.

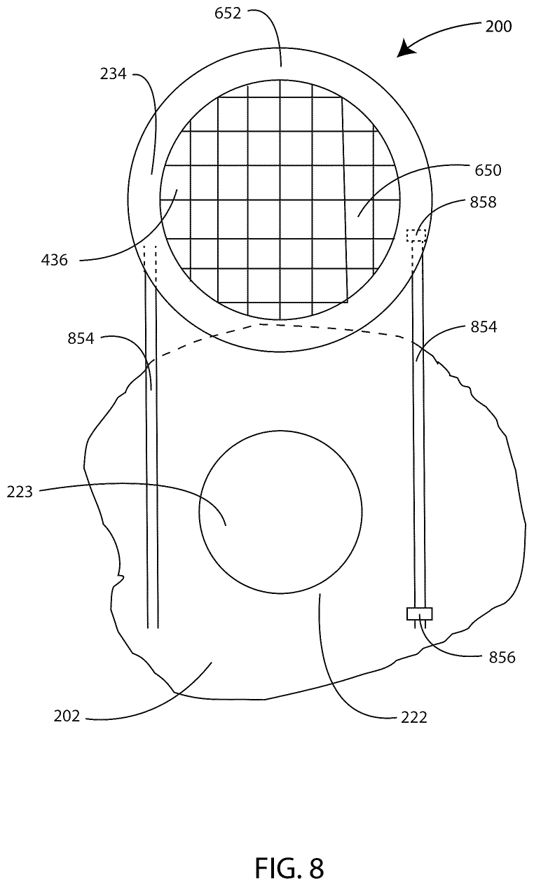

### Foreign Material Guard as Tip Portion—Sliding Tip (FIGS. 8-10)

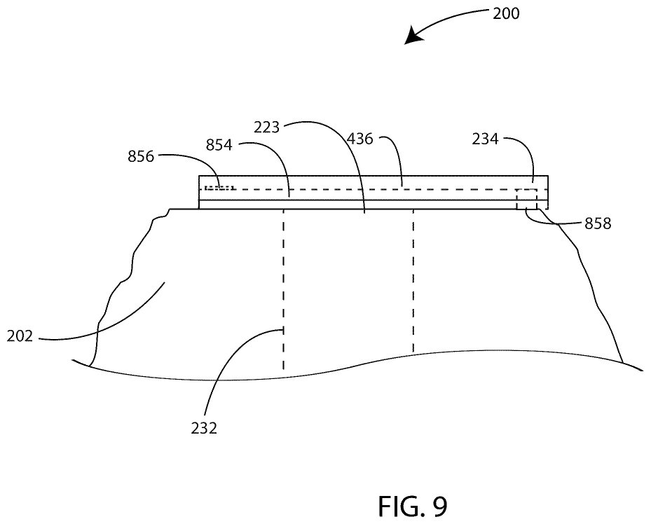

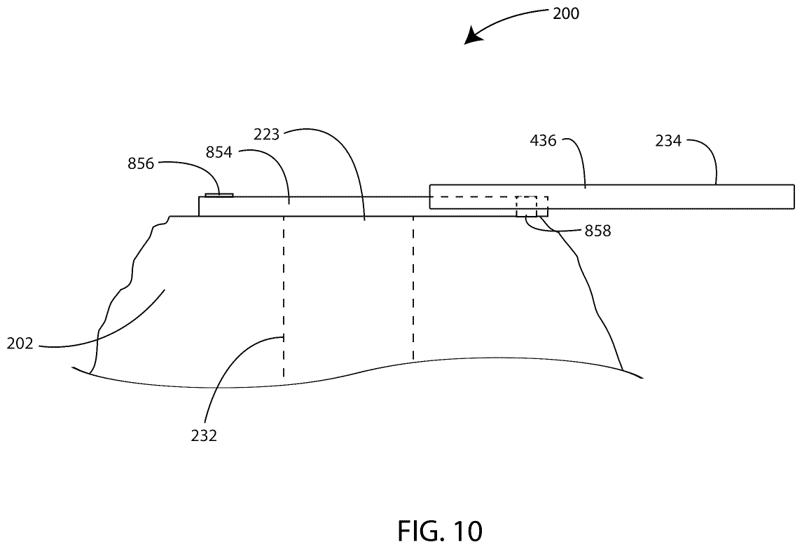

Referring now to FIGS. 8-10, schematic views of an in-the-ear style custom ear-wearable device are shown in accordance with various embodiments herein. FIG. 8 depicts a schematic top view of a portion of an in-the-ear style custom ear-wearable device with a tip portion in a second position. FIG. 9 depicts a schematic front view of a portion of the in-the-ear style custom ear-wearable device of FIG. 8 with the tip portion in a first position. FIG. 10 depicts a schematic front view of a portion of the in-the-ear style custom ear-wearable device of FIG. 8 with the tip portion in a second position.

The ear-wearable devices depicted by FIGS. 8-10 can include many substantially similar components to the ear-wearable devices shown and described by FIGS. 2-7. In various embodiments, the ear-wearable device 200 can include a housing 202 having an aperture end (not shown in this view) and an ear canal end 222 defining an acoustic outlet 223. The ear-wearable device 200 can further include a receiver 212 within the housing 202 and an acoustic tube 232 (best seen in FIG. 9) between the receiver 212and the acoustic outlet 223.

In various embodiments, the ear-wearable device 200 can include a foreign material barrier 436 disposed over a portion of the acoustic tube 232 and a tip portion 234 disposed at the ear canal end 222. The tip portion 234 can be configured to move between a first position (as seen in FIG. 9) and a second position (as seen in FIGS. 8 and 10).

In some embodiments, the tip portion 234 is integral with the foreign material barrier 436. In the example of FIGS. 8-10, the tip portion 234 and the foreign material barrier 436 are the same part, such that a movement of the tip portion 234 is equivalent to a movement of the foreign material barrier 436. In such embodiments, the movement of the tip portion 234 from the first position (as seen in FIG. 9) to the second position (as seen in FIGS. 8 and 10) causes the foreign material barrier 436 to move with respect to the housing 202.

In various embodiments, when in the first position, the foreign material barrier 436 is configured to cover the acoustic outlet 223. In various embodiments, when in the second position (as seen in FIGS. 8 and 10), the foreign material barrier 436 does not cover the acoustic outlet 223. In various embodiments, when in the second position at least a portion of the foreign material barrier 436 does not overlap with the housing 202. In the example of FIGS. 8 and 10, the majority of the foreign material barrier 436 does not overlap with the housing 202. In some embodiments, at least 50%, 60%, 70%, 80%, 90%, or 100%, or an amount falling within a range between any of the foregoing of the foreign material barrier 436 does not overlap with the housing 202.

In the example of FIGS. 8-10, the tip portion 234 is configured to translate laterally between the first position and the second position. In such a configuration, the ear-wearable device 200 can include guiding rails 854. In various embodiments, the tip portion is 234 configured to translate along the guiding rails 854 between the first position and the second position.

In various embodiments, the guiding rails 854 are configured to secure the tip portion 234 to the housing 202 of the ear-wearable device 200. In various embodiments, the guiding rails 854 can be rigidly connected to the housing 202 of the ear-wearable device 200.

In various embodiments, the walls of the guiding rails 854 and the edges of the tip portion 234 are shaped to interlock with each other. In various embodiments, the walls of the guiding rails have tapered profiles (e.g., a dovetail shape, where the width of the guiding rail decreases from top to bottom.) In various embodiments, the bottom surface of the tip portion 234 can include channels configured to receive the guiding rails. The channels defined in the tip portion can have a matching, interlocking profile to that of the guiding rails (e.g., the channel width can decrease from top to bottom). Such a configuration is configured to prevent the tip portion 234 from becoming dislodged from the ear-wearable device 200.

In the example of FIGS. 8-10, the ear-wearable device 200 includes two guiding rails 854. Each guiding rail is configured to connect to an opposing side of the frame 652 of the foreign material barrier 436.

In various embodiments, the guiding rail 854 is configured to allow for movement of the tip portion 234 relative to the housing 202. The guiding rail can include any suitable combination of features (e.g., dovetails or stops) to prevent the tip portion 234 from becoming dislodged from the ear-wearable device 200. In various embodiments, the guiding rail 854 can be any suitable type of linear guide including, but not limited to sliding contact linear guides, sleeve bearing linear guides, profiled rail linear guides, V-groove linear guiding rails, or the like.

In various embodiments, the ear-wearable device 200 can include a first stopper notch 856. In various embodiments, the first stopper notch 856 is configured to fix the tip portion 234 in the first position. For instance, when the tip portion is in its first position, the first stopper notch 856 is configured to engage with the tip portion 234 and retain it in the first position. However, the engagement between the tip portion 234 and the first stopper notch 856 is configured to be weak enough such that a tangential force applied to the tip portion (e.g., a user sliding the tip portion) is sufficient to overcome the tension between the tip portion 234 and the first stopper notch 856, allowing the tip portion to translate from the first position to the second position.

In various embodiments, the ear-wearable device 200 can include a second stopper notch 858. In various embodiments, the second stopper notch 858 is configured to limit the translation of the tip portion 234. For instance, the second stopper notch 858 can be placed at the end of the guiding rail 854. In such an embodiment, the second stopper notch 858 is configured to stop the translation of the tip portion 234 as it reaches the end of the guiding rail 854, preventing the tip portion from becoming dislodged from the ear-wearable device.

The examples of FIGS. 4-10 show and describe an ear-wearable device having a tip portion that is also a foreign material guard. However, other configurations are shown and described herein.

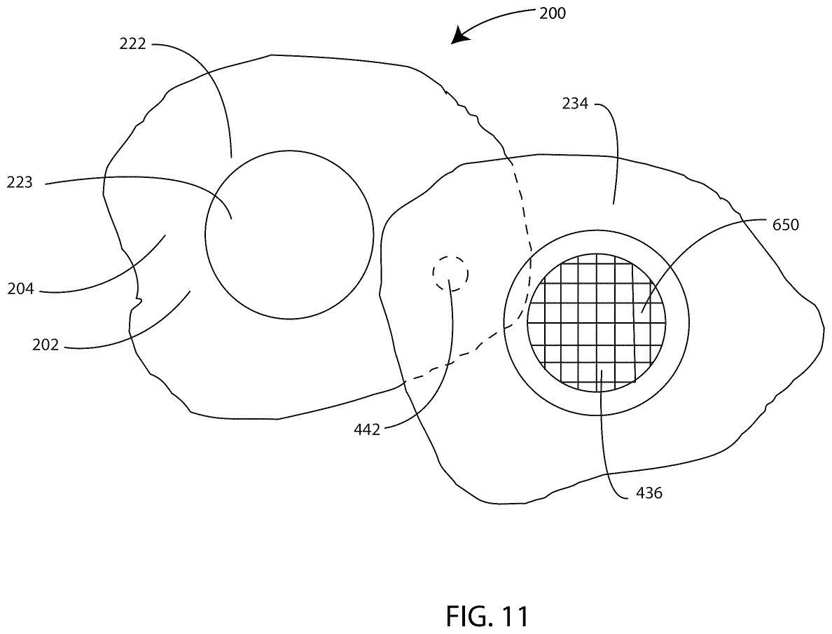

### Foreign Material Guard in Tip Portion—Rotating Tip (FIGS. 11-13)

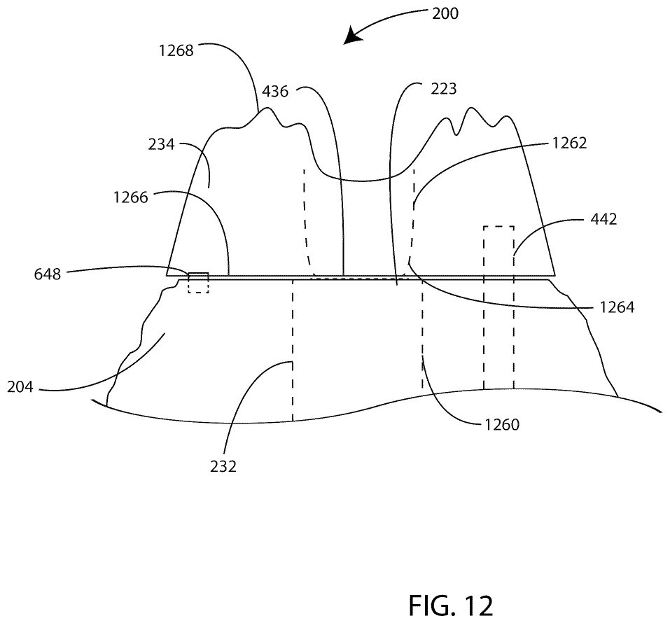

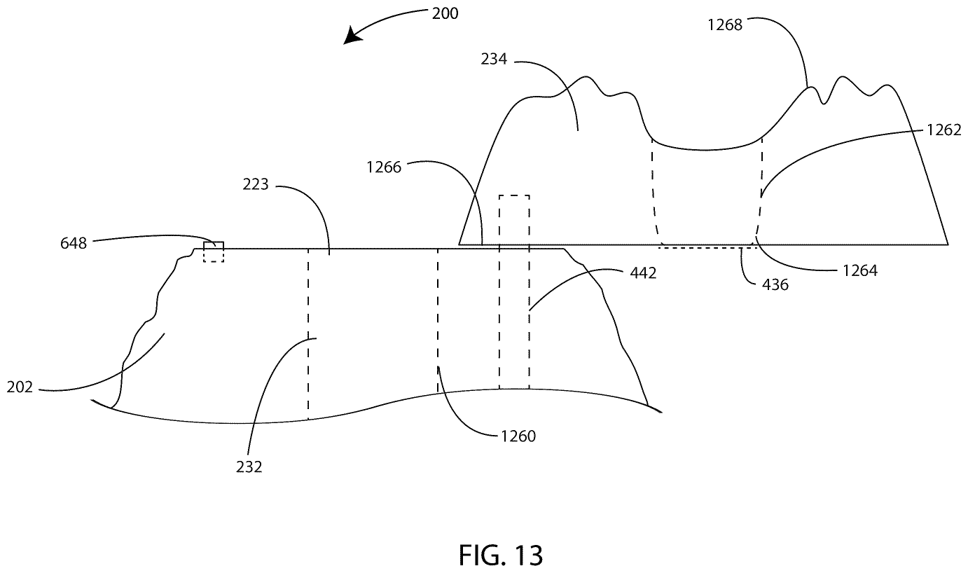

Referring now to FIGS. 11-13, schematic views of an in-the-ear style custom ear-wearable device are shown in accordance with various embodiments herein. FIG. 11 depicts a schematic top view of a portion of an in-the-ear style custom ear-wearable device with a tip portion in a second position. FIG. 12 depicts a schematic front view of a portion of the in-the-ear style custom ear-wearable device of FIG. 11 with the tip portion in a first position. FIG. 13 depicts a schematic front view of a portion of the in-the-ear style custom ear-wearable device of FIG. 11 with the tip portion in the second position.

The ear-wearable devices depicted by FIGS. 11-13 can include many substantially similar components to the ear-wearable devices shown and described by FIGS. 2-10. In various embodiments, the ear-wearable device 200 can include a housing 202 having an aperture end (not shown in this view) and an ear canal end 222 defining an acoustic outlet 223. The ear-wearable device 200 can further include a receiver 212 within the housing 202 and an acoustic tube 232 (best seen in FIG. 12) between the receiver 212 and the acoustic outlet 223.

In various embodiments, the ear-wearable device 200 can include a foreign material barrier 436 disposed over a portion of the acoustic tube 232 and a tip portion 234 disposed at the ear canal end 222. The tip portion 234 can be configured to move between a first position (as seen in FIG. 12) and a second position (as seen in FIGS. 11 and 13).

In various embodiments, the acoustic tube 232 can include an acoustic tube proximal portion 1260 and an acoustic tube distal portion 1262. In various embodiments, the ear-wearable device 200 can include a foreign material barrier 436 disposed between the acoustic tube proximal portion 1260 and the acoustic tube distal portion 1262.

In various embodiments, the ear-wearable device 200 can include a tip portion 234 disposed at the ear canal end 222. The tip portion 234 can define the acoustic tube distal portion 1262. In various embodiments, the tip portion 234 is configured to move between a first position (as seen in FIG. 12) and a second position (as seen in FIGS. 11 and 13). In various embodiments, a movement of the tip portion 234 from the first position to the second position is configured to move foreign material in a lateral direction away from the acoustic tube 232. A lateral direction as defined herein is a direction parallel to the plane defined by the foreign material barrier.

In the example of FIGS. 11-13, the foreign material barrier 436 is rigidly connected to the tip portion 234 such that a movement of the tip portion 234 is equivalent to a movement of the foreign material barrier 436. In such embodiments, the movement of the tip portion 234 from the first position (as seen in FIG. 12) to the second position (as seen in FIGS. 11 and 13) causes the foreign material barrier 436 to move with respect to the housing 202.

In various embodiments, the foreign material barrier 436 is rigidly connected to the tip portion 234 at a tip portion proximal end 1266. In various embodiments, the foreign material barrier 436 is rigidly connected to the tip portion 234 such that the foreign material barrier abuts a proximal end of the acoustic tube distal portion 1262. The foreign material barrier can be joined to the tip portion 234 by any suitable means such as adhesives, or the like.

In various embodiments, the movement of the tip portion 234 from the first position to the second position is configured to move foreign material in a lateral direction away from the acoustic tube 232. In some embodiments, the acoustic tube distal portion 1262 can taper in diameter from the tip portion distal end 1268 to the tip portion proximal end 1266, forming an edge 1264 adjacent to the foreign material barrier 436.

In various embodiments, the tip portion 234 can be from any suitable material or materials, including, but not limited to silicone, urethane, acrylates, flexible epoxy, acrylate urethane, and combinations thereof. In some embodiments, the tip portion 234 is formed from the same material or materials as the shell 204. In some embodiments, the tip portion 234 is formed from different materials than the shell 204.

In various embodiments, the tip portion 234 can be manufactured utilizing any suitable technique or techniques such as injection-molding, 3D printing, or the like. In some embodiments, the tip portion 234 is formed from the same manufacturing process as the shell 204. In some embodiments, the tip portion 234 is formed from a different manufacturing process than the shell 204.

In various embodiments, the tip portion 234 is configured to be flush with the shell 204. For instance, the tip portion proximal end 1266 can have approximately the same cross-sectional area as the shell 204 at the ear canal end 222 of the ear-wearable device 200.

Similar to embodiments of FIGS. 4-7, the tip portion 234 of FIGS. 11-13 is configured to rotate between the first position and the second position. In various embodiments, the ear-wearable device 200 can include a pivot bearing 442. In various embodiments, the tip portion 234 is configured to rotate about the pivot bearing 442 between the first position and the second position. As best seen in FIGS. 12-13, the pivot bearing 442 is configured to rotatably connect the tip portion 234 to the housing 202 of the ear-wearable device 200.

In various embodiments, the ear-wearable device 200 can include a stopper notch 648. In various embodiments, the stopper notch 648 is configured to fix the tip portion 234 in the first position. In some embodiments, the stopper notch 648 is further configured to limit the rotation of the tip portion with respect to the housing 202.

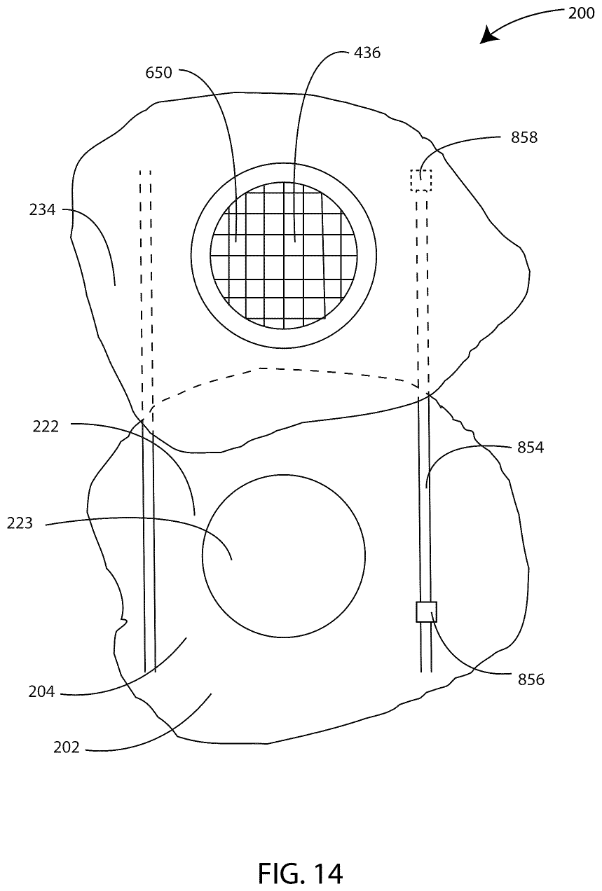

### Foreign Material Guard in Tip Portion—Sliding Tip (FIGS. 14-16)

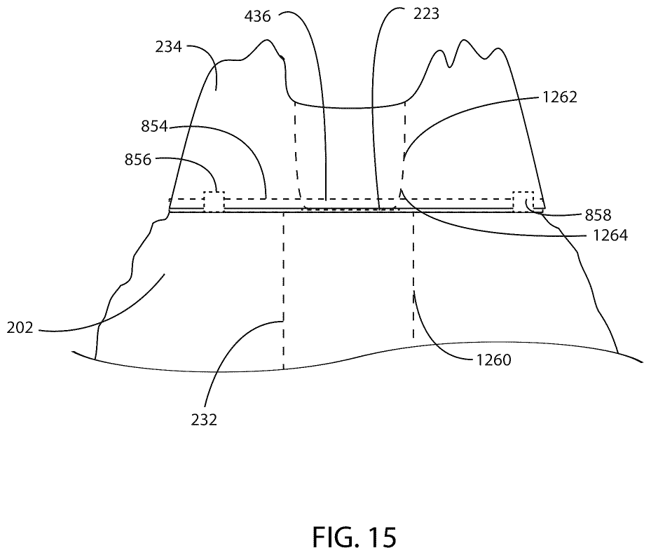

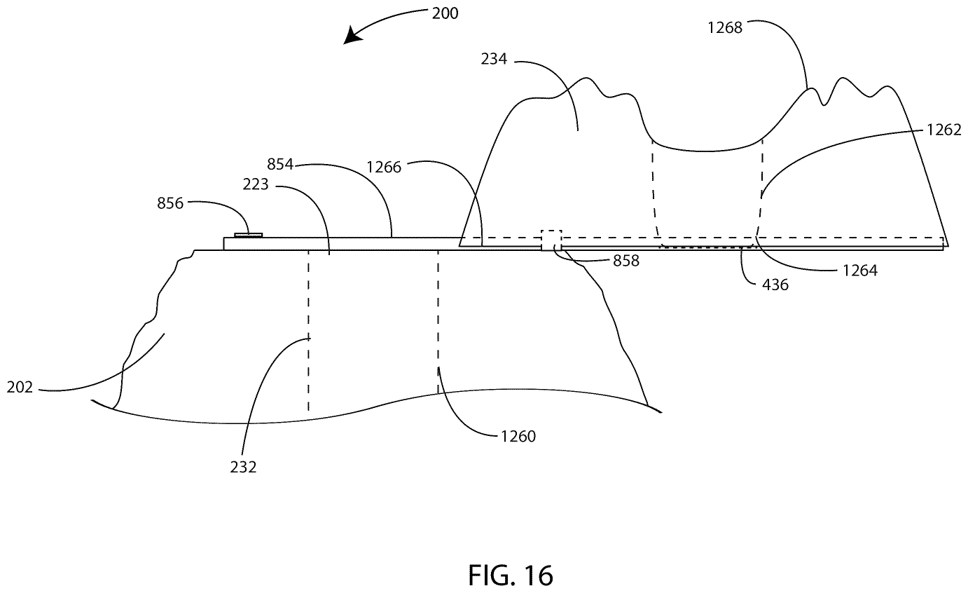

Referring now to FIGS. 14-16, schematic views of an in-the-ear style custom ear-wearable device are shown in accordance with various embodiments herein. FIG. 14 depicts a schematic top view of a portion of an in-the-ear style custom ear-wearable device with a tip portion in a second position. FIG. 15 depicts a schematic front view of a portion of the in-the-ear style custom ear-wearable device of FIG. 14 with the tip portion in a first position. FIG. 16 depicts a schematic front view of a portion of the in-the-ear style custom ear-wearable device of FIG. 14 with the tip portion in the second position.

The ear-wearable devices depicted by FIGS. 14-16 can include many substantially similar components to the ear-wearable devices shown and described by FIGS. 2-13. In various embodiments, the ear-wearable device 200 can include a tip portion 234 disposed at the ear canal end 222. The tip portion can define the acoustic tube distal portion. In various embodiments, the tip portion 234 is configured to move between a first position (as seen in FIG. 15) and a second position (as seen in FIGS. 14 and 16). In the example of FIGS. 14-16, the foreign material barrier 436 is rigidly connected to the tip portion 234 such that a movement of the tip portion 234 is equivalent to a movement of the foreign material barrier 436.

In the example of FIGS. 14-16, the tip portion 234 is configured to translate laterally between the first position and the second position. In such a configuration, the ear-wearable device 200 can include guiding rails 854. In various embodiments, the tip portion 234 is configured to translate along the guiding rails 854 between the first position and the second position.

In various embodiments, the ear-wearable device 200 can include a first stopper notch 856. In various embodiments, the first stopper notch 856 is configured to fix the tip portion 234 in the first position. In various embodiments, the ear-wearable device 200 can include a second stopper notch 858. In various embodiments, the second stopper notch 858 is configured to limit the translation of the tip portion 234. The ear-wearable device 200 can include any suitable configuration of guiding rails, interlocking shapes, and stopper notches such as described in the context of FIGS. 8-10.

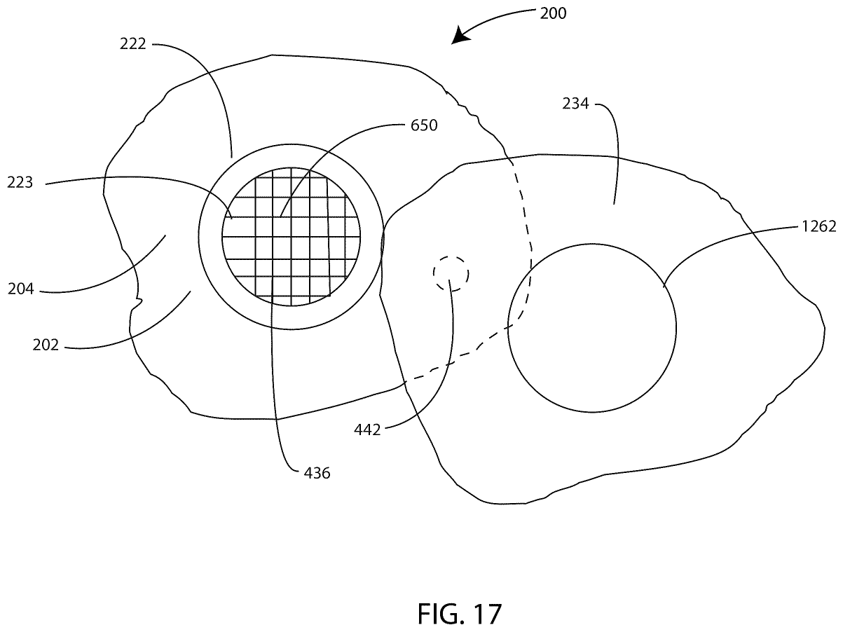

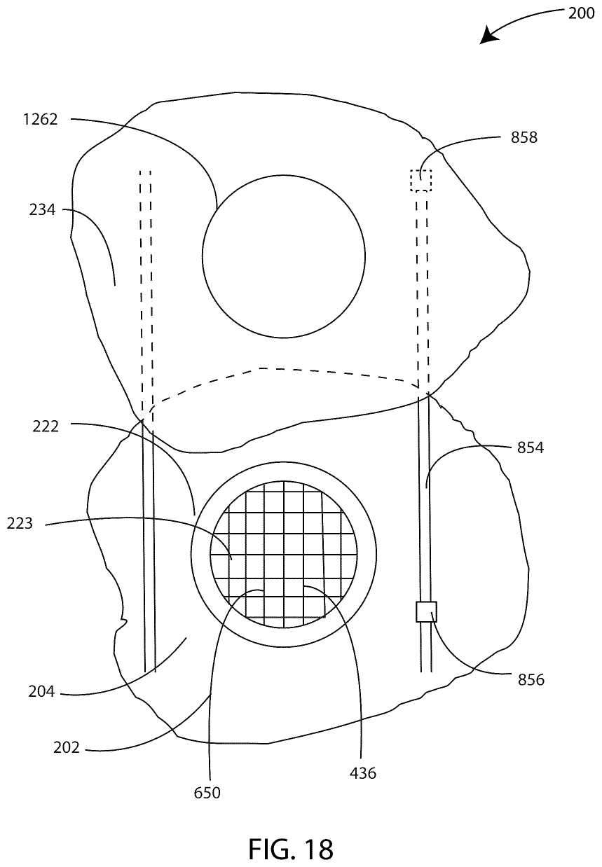

### Foreign Material Guard on Shell (FIGS. 17-18)

Referring now to FIGS. 17-18, schematic views of an in-the-ear style custom ear-wearable device are shown in accordance with various embodiments herein. FIG. 17 depicts a schematic top view of a portion of an in-the-ear style custom ear-wearable device with a tip portion in a second position. FIG. 18 depicts a schematic top view of a portion of a different in-the-ear style custom ear-wearable device with a tip portion in a second position.

The ear-wearable devices depicted by FIGS. 17-18 can include many substantially similar components to the ear-wearable devices shown and described by FIGS. 2-16. The ear-wearable device 200 of FIG. 17 can be substantially similar to the ear-wearable device of FIGS. 11-13 except that the foreign material barrier 436 is rigidly connected to the housing 202 of the ear-wearable device (rather than the tip portion 234). The ear-wearable device 200 of FIG. 18 can be substantially similar to the ear-wearable device of FIGS. 14-16 except that the foreign material barrier 436 is rigidly connected to the housing 202 of the ear-wearable device (rather than the tip portion 234).

In various embodiments, a movement of the tip portion 234 from the first position to the second position is configured to push foreign material in a lateral direction off of and away from the foreign material barrier 436, and away from the acoustic tube.

In the embodiment of FIGS. 17-18, the movement of the tip portion 234 from the first position to the second position causes the tip portion 234 to move with respect to the foreign material barrier 436. In some embodiments, such as seen in FIG. 12, the acoustic tube distal portion 1262 can taper in diameter from the tip portion distal end 1268 to the tip portion proximal end 1266, forming an edge 1264 adjacent to the foreign material barrier 436. In some embodiments, the edge 1264 is configured to scape against the foreign material barrier and laterally push the foreign material with respect to the foreign material barrier 436 as the tip portion 234 moves from the first position to the second position.

In the embodiment of FIGS. 17-18, the foreign material barrier 436 is rigidly connected to the housing 202 at the ear canal end 222 of the ear-wearable device 200. In various embodiments, the foreign material barrier 436 is rigidly connected to the housing such that the foreign material barrier abuts a distal end of the acoustic tube proximal portion 1260. The foreign material barrier 436 can be joined the housing 202 by any suitable means such as adhesives, or the like.

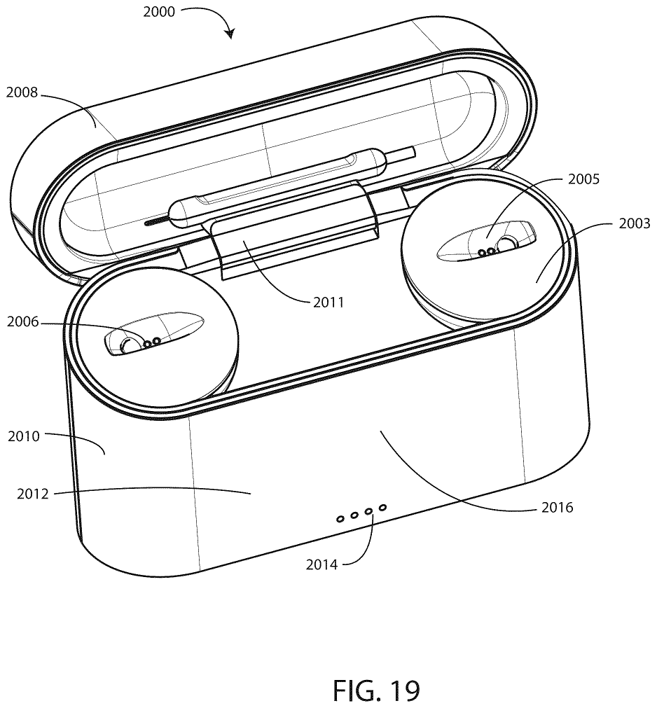

### Case (FIG. 19)

Referring now to FIG. 19, a perspective view of a case is shown in accordance with various embodiments herein. Embodiments of the case 2000 are directed to storing, protecting, and charging ear-wearable device(s) contained within the case.

In various embodiments, the case 2000 can have an interior top surface 2003 and one or more indentations 2005 defined in the interior top surface 2003. Each indentation 2005 is configured to receive an ear-wearable device 200. Each indentation 2005 can include a case charging structure 2006 for charging a rechargeable battery of an ear-worn device via ear-worn device charging contacts.

The case can have a case main body 2010 and a lid 2008. The case main body 2010 may further include a case battery 2012 and case electronics configured to charge one or more ear-wearable devices among other optional functions. The case main body 2010 may be connected to the lid 2008 by a hinge 2011 such that the lid can move the case between an open and closed position. 2014

In various embodiments, the case 2000 may include case display 2014 to provide a visual indicator regarding the status of components within the case 2000. For example, the case display 2014 may communicate the power level/status of the ear-worn devices or the case battery 2012 contained within the case 2000. Alternatively, or in addition, the display 2014 can include a screen, touch screen, or other type of display device.

In various examples, the case 2000 may be configured or adapted such that the ear-wearable devices contained within the case are charging when the case is in a closed position, and, for example, not charging when the case is in the open position. Specifically, the case may include one or more contact points that interact with one another when the case is in the closed position to charge the ear-worn devices. As such, a user knows that the ear-worn devices contained within the case are charging when the case is in a closed position. In one or more embodiments, the case may also be configured or adapted such that the ear-worn devices contained within the case may charge when the case is in the open position. In various embodiments, an ear-worn device can be configured to execute the debris removal protocol when the ear-wearable device 200 is positioned within the case 2000 and/or when the case 2000 is charging the ear-worn device.

In various embodiments the case main body 2010 may further include a case heat source 2016. The case heat source can be any suitable type of case heat source such as, a resistive heater, or the like. In various embodiments, the case heat source 2016 is configured to direct heat into the acoustic outlet 223 of the ear-wearable device 200 when the ear-wearable device is positioned within the case 2000. In various embodiments, the case heat source 2016 is configured to direct heat into the acoustic outlet 223 of the ear-worn device for a predetermined time interval. In some embodiments, the predetermined time interval can be greater than or equal to 10 seconds, 15 seconds, 20 seconds, or 30 seconds. In some embodiments, the predetermined time interval can be less than or equal to 100 seconds, 75 seconds, 50 seconds, or 30 seconds. In some embodiments, the predetermined time interval can fall within a range of 10 seconds to 100 seconds, or 20 seconds to 75 seconds, or 25 seconds to 50 seconds, or can be about 30 seconds.

In some embodiments, heating the acoustic outlet 223 of an ear-wearable device 200 can cause foreign material to lose moisture and become less viscous. In some embodiments, the reduced viscosity of the foreign matter can make it easier to remove from the foreign material barrier 436.

In various embodiments a method of moving foreign material from an ear-wearable device 200 can include applying heat to the acoustic channel of the ear-wearable device via the acoustic outlet 223. The acoustic channel is the passage defined by the acoustic tube 232. Heat can be applied using any suitable heat source, such as the case heat source 2016, or the like. In various embodiments, after applying heat to the acoustic channel, the tip portion 234 can be moved from a first position to a second position, moving foreign material in a direction away from the acoustic tube, either by moving the foreign material barrier along with the tip or by scraping foreign material off of the foreign material barrier as the tip moves. The ear-wearable device 200 can be jostled to cause foreign material to fall away from foreign material barrier and away from the housing.

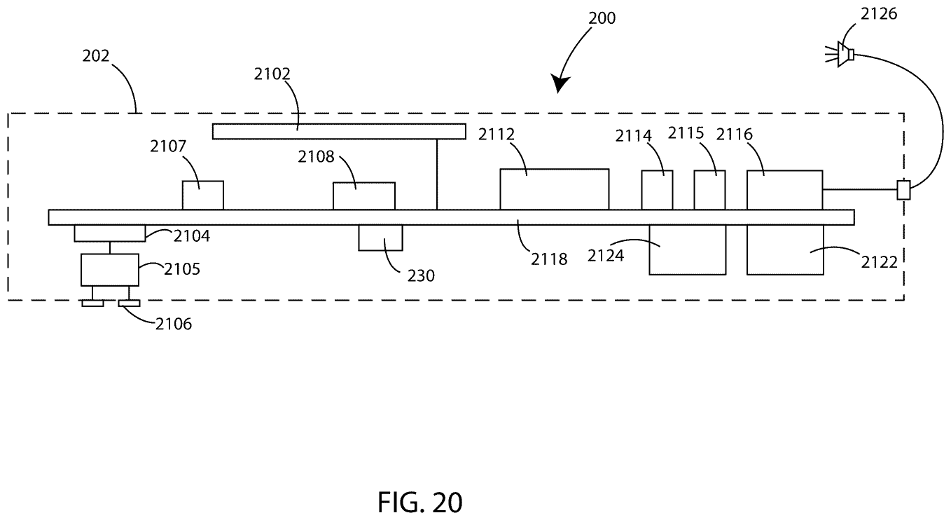

### Schematic of Internal Components of Ear-wearable Device (FIG. 20)

Referring now to FIG. 20, a schematic block diagram is shown with various components of an ear-wearable device 200 in accordance with various embodiments. These components are enclosed within the housing 202 of the ear-wearable device with is formed by the faceplate and the test shell. The block diagram of FIG. 20 represents a generic ear-wearable device for purposes of illustration. The ear-wearable device 200 shown in FIG. 20 includes several components electrically connected to a circuit board 2118 (e.g., flexible circuit board) which is disposed within housing 202. A power supply circuit 2104 can include a battery 2105, can be electrically connected to the circuit board 2118, and provides power to the various components of the ear-wearable device 200. In some embodiments, one or more charging contacts 2106 are connected to the battery 2105 and are configured to interface with the charging contacts of the charging case. In other embodiments, the charting contacts are not present and the battery 2105 is replaced when exhausted.

One or more microphones 2107 are electrically connected to the circuit board 2118, which provides electrical communication between the microphones 2107 and a digital signal processor (DSP) 2112. Among other components, the DSP 2112 incorporates or is coupled to audio signal processing circuitry configured to implement various functions described herein. One or more user input devices 230 (e.g., on/off, volume, mic directional settings) are electrically coupled to the DSP 2112 via the circuit board 2118.

A sensor package 2114 can be coupled to the DSP 2112 via the circuit board 2118. The sensor package 2114 can include one or more different specific types of sensors. The ear-wearable device includes an ear-wearable device IMU 2115. The IMU 2115 is configured to detect a vibration sequence as a part of a pairing method for the wireless communication device 2108, among other useful data that can be ascertained from IMU 2115.

As used herein the term “inertial measurement unit” or “IMU” shall refer to an electronic device that can generate signals related to a body's specific force and/or angular rate. IMUs herein can include one or more accelerometers (3, 6, or 9 axis) to detect linear acceleration, a gyroscope to detect rotational rate, or both. In some embodiments, in the alternative or in addition, an IMU includes a magnetometer to detect a magnetic field.

An audio output device 2116 is electrically connected to the DSP 2112 via the circuit board 2118. In some embodiments, the audio output device 2116 comprises a speaker (coupled to an amplifier). In other embodiments, the audio output device 2116 comprises an amplifier coupled to a receiver 2126 adapted for positioning within an ear of a wearer. The receiver 2126 can include an electroacoustic transducer, speaker, or loudspeaker.

The ear-wearable device 200 may incorporate a wireless communication device 2108 coupled to the circuit board 2118 and to an antenna 2102 directly or indirectly via the circuit board 2118. The communication device 2108 can be a high-frequency radio, such as a 2.4 GHz radio. The radio can conform to an IEEE 802.11 (e.g., WiFi®) or a Bluetooth® (e.g., Bluetooth® low energy, Bluetooth® 4.2 or 5.0, and Bluetooth® Long Range) specification, for example. It is understood that ear-wearable devices of the present disclosure can employ other radios, such as a 900 MHz radio.

Ear-wearable devices of the present disclosure can be configured to receive streaming audio (e.g., digital audio data or files) from an electronic or digital source. Ear-wearable devices herein can also be configured to switch communication schemes to a long-range mode of operation, wherein, for example, one or more signal power outputs may be increased, and data packet transmissions may be slowed or repeated to allow communication to occur over longer distances than that during typical modes of operation. Representative electronic/digital sources (also serving as examples of accessory devices herein) include an assistive listening system, a TV streamer, a radio, a smartphone, a cell phone/entertainment device (CPED), a pendant, wrist-worn device, or other electronic device that serves as a source of digital audio data or files.

The communication device 2108 can be configured to communicate with one or more external devices, such as a wireless communication device of a charging case, a wireless communication device of another ear-wearable device, a wireless communication device of a smart phone, or a wireless communication device of another system, such as other systems discussed herein, in accordance with various embodiments. In various embodiments, the communication device 2108 can be configured to communicate with an external visual display device such as a smart phone, a video display screen, a tablet, a computer, or the like.

In various embodiments, the ear-wearable device 200 can also include a control circuit 2122 and a memory storage device 2124. The control circuit 2122 can be in electrical communication with other components of the device. The control circuit 2122 can execute various operations, such as those described herein. The control circuit 2122 can include various components including, but not limited to, a microprocessor, a microcontroller, an FPGA (field-programmable gate array) processing device, an ASIC (application specific integrated circuit), or the like. The memory storage device 2124 can include both volatile and non-volatile memory. The memory storage device 2124 can include ROM, RAM, flash memory, EEPROM, SSD devices, NAND chips, and the like. The memory storage device 2124 can be used to store data from sensors as described herein and/or processed data generated using data from sensors as described herein, including, but not limited to, information regarding exercise regimens, performance of the same, visual feedback regarding exercises, and the like.

It is noted that the structure and housing of a second ear-wearable device is not illustrated herein but may be similar to or identical to the first ear-wearable device.

Ear-wearable devices of the present disclosure can incorporate an antenna arrangement coupled to a high-frequency radio, such as a 2.4 GHz radio. The radio can conform to an IEEE 802.11 (e.g., WiFi® standard) or Bluetooth® standard (e.g., BLE, Bluetooth® 4.2 or 5.0) specification, for example. It is understood that ear-wearable devices of the present disclosure can employ other radios, such as a 900 MHz radio. Ear-wearable devices of the present disclosure can be configured to receive streaming audio (e.g., digital audio data or files) from an electronic or digital source. Representative electronic/digital sources (also referred to herein as accessory devices) include an assistive listening system, a TV streamer, a radio, a smart phone, a cell phone/entertainment device (CPED) or other electronic device that serves as a source of digital audio data or files.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. An ear-wearable device comprising:
a housing comprising:
an aperture end; and
an ear canal end defining an acoustic outlet;
a receiver within the housing;
an acoustic tube between the receiver and the acoustic outlet;
a foreign material barrier disposed over a portion of the acoustic tube; and
a tip portion disposed at the ear canal end, wherein the tip portion is configured to move between a first position and a second position;
wherein a movement of the tip portion from the first position to the second position is configured to move foreign material in a direction away from the acoustic tube.

2. The ear-wearable device of claim 1, wherein the foreign material barrier comprises a mesh.

3. The ear-wearable device of claim 1, wherein the foreign material barrier comprises a plate defining openings.

4. The ear-wearable device of claim 1, wherein the tip portion comprises the foreign material barrier, wherein the movement of the tip portion from the first position to the second position causes the foreign material barrier to move with respect to the housing.

5. The ear-wearable device of claim 4, wherein when in the second position, the foreign material can be pushed though the foreign material barrier without obstructing the acoustic tube.

6. The ear-wearable device of claim 4, wherein the tip portion comprises a mesh.

7. The ear-wearable device of claim 1, wherein the foreign material barrier is disposed on the housing, wherein the movement of the tip portion from the first position to the second position causes the tip portion to move with respect to the foreign material barrier.

8. The ear-wearable device of claim 1, wherein the tip portion is configured to rotate between the first position and the second position.

9. The ear-wearable device of claim 8, further comprising:
a pivot bearing, wherein the tip portion is configured to rotate about the pivot bearing; and
a stopper notch configured to fix the tip portion in the first position.

10. The ear-wearable device of claim 1, wherein the tip portion is configured to translate laterally between the first position and the second position.

11. The ear-wearable device of claim 10, further comprising:
a guiding rail, wherein the tip portion is configured to translate along the guiding rail; and
a stopper notch configured to limit the translation of the tip portion.

12. The ear-wearable device of claim 1, wherein, when the tip portion is in the first position, the tip portion covers the acoustic outlet.

13. The ear-wearable device of claim 1, wherein, when the tip portion is in the second position, at least 90% of the acoustic tube proximal portion is not covered by the tip portion, and the foreign material barrier does not overlap with the housing.

14. An ear-wearable device comprising:
a housing comprising:
an aperture end; and
an ear canal end defining an acoustic outlet;
a receiver within the housing;
an acoustic tube between the receiver and the acoustic outlet, the acoustic tube comprising an acoustic tube proximal portion and an acoustic tube distal portion;
a foreign material barrier disposed between the acoustic tube proximal portion and the acoustic tube distal portion; and
a tip portion disposed at the ear canal end, the tip portion comprising the acoustic tube distal portion; wherein the tip portion is configured to move between a first position, and a second position;
wherein a movement of the tip portion from the first position to the second position is configured to move foreign material in a direction away from the acoustic tube.

15. The ear-wearable device of claim 14, wherein the foreign material barrier is disposed on the tip portion, wherein the movement of the tip portion from the first position to the second position causes the foreign material barrier to move with respect to the housing.

16. The ear-wearable device of claim 14, wherein the foreign material barrier is disposed on the housing, wherein the movement of the tip portion from the first position to the second position causes the tip portion to move with respect to the foreign material barrier.

17. The ear-wearable device of claim 14, wherein the tip portion is configured to rotate between the first position and the second position or translate laterally between the first position and the second position.

18. A method of moving foreign material from an ear-wearable device, the ear-wearable device comprising a housing defining an acoustic outlet, a receiver disposed inside the housing, an acoustic tube defined between the receiver and the acoustic outlet, and a foreign material barrier disposed over a portion of the acoustic tube; the method comprising:
moving a tip portion from a first position to a second position, wherein a movement of the tip portion from the first position to the second position moves foreign material in a direction away from the acoustic tube.

19. The method of claim 18 wherein the foreign material barrier is disposed on the tip portion, wherein the movement of the tip portion from the first position to the second position causes the foreign material barrier to move with respect to the housing, further comprising the step of removing the foreign material from the foreign material barrier.

20. The method of claim 18 further comprising applying heat to the acoustic channel prior to moving the tip portion from the first position to the second position.
